(19) United States
(12) Patent Application Publication
(10) Pub. No.: US 2026/0049915 A1
(43) Pub. Date: Feb. 19, 2026

(54) APPARATUS AND METHOD FOR METAL TREATMENT ANALYSIS

(71) Applicant: Associated Spring US, LLC, Brighton, MI (US)

(72) Inventors: Jason SICOTTE, Southbury, CT (US); Joaquin DAVIS, Maumee, OH (US)

(21) Appl. No.: 19/103,031

(22) PCT Filed: Aug. 10, 2023
(86) PCT No.: PCT/US2023/029933

§ 371 Date: Feb. 11, 2025

Related U.S. Application Data
(60) Provisional application No. 63/397,021, filed on Aug. 11, 2022.

(51) Int. Cl. G01N 3/34; C21D 7/06; G01N 3/04

(52) U.S. Cl. CPC G01N 3/34; C21D 7/06; G01N 3/04; G01N 2203/0005; G01N 2203/0019; G01N 2203/0085; G01N 2203/04

(57) ABSTRACT

An improved peening process to simulate the shadowing effect of workpieces that are being peened to more accurately determine the degree to which a workpiece has been peened, and to an improved test strip holder that can be used to better simulate the shadowing effect of workpieces that are being peened.

The present disclosure claims priority on U.S. Provisional Patent Application Ser. No. 63/397,021 filed Aug. 11, 2022, which is fully incorporated herein by reference.

### FIELD OF DISCLOSURE

The present disclosure relates generally to metal treatment processes, particularly to a metal treatment process that includes the use of peening, and even more particularly to an improved peening process to simulate the shadowing effect of workpieces that are being peened to more accurately determine the degree to which a workpiece has been peened.

### BACKGROUND OF DISCLOSURE

Metal workpieces are commonly processed to obtain the desired final properties of the workpiece. One type of metal treatment process is shot peening. Shot peening is a cold working process that is used to produce a compressive residual stress layer and modify the mechanical properties of metals. The process involves striking the metal surface with shot (e.g., spherically-shaped metal particles, spherically-shaped metal ceramic particles, etc.) with force sufficient to create plastic deformation in the surface of the workpiece. One purpose of shot peening a workpiece is to inhibit or prevent the propagation of microcracks in the surface of the workpiece. Another purpose of shot peening is to relieve tensile stresses that have built-up in the workpiece due to the grinding of the workpiece and replace such tensile stresses with compressive stresses. The shot peening process is commonly used on springs, gear parts, cams, camshafts, connecting rods, crankshafts, gearwheels, turbine blades, etc. The peening process is particularly important for the processing of springs (e.g., leaf springs, extension springs, compression springs, etc.). The peening process is used on springs to improve the fatigue life of the spring.

During a peening process, an Almen strip is commonly used to measure the degree to which a workpiece has been subjected to the peening process. During a peening process, both the workpiece to be peened and an Almen strip that is mounted in a strip holder is subjected to peening. Common process for propelling the shot to the surface of the workpiece includes air blast systems and centrifugal blast wheels. After the completion of the peening process, the Almen strip is removed from the strip holder and the degree of deformation of the Almen strip is measured to determine the amount of compressive stresses in the Almen strip created by the shot peening operation.

The amount of coverage of the treated workpiece during a peening process can also be determined by analyzing the percentage of the surface of the Almen strip that has been indented once or more. Many factors can affect the coverage density of the treated workpiece, such as shot flow volume, exposure time, shot properties (e.g., size), and workpiece properties. Peened coverage of a treated workpiece is commonly monitored by visual examination. Likewise, many facts affect the intensity of the peening process (e.g., shot size, shot density, shot hardness, shot velocity, etc.). Saturation is the time required for 98%+peening coverage of the workpiece and is the time at which additional peening to double time yields only a 10% increase in Almen arc height.

Almen strips are commonly used to both measure coverage density and peening intensity of a workpiece. An Almen strip 100 is a thin strip of SAE 1070 steel (as illustrated in FIG. 1) used to quantify the intensity of a shot in the peening process. The Almen strip is placed in the chamber with the workpiece to be shot peened. Compressive stress caused by the peening operation results in the deformation of the Almen strip, which deformation is then measured using a gauge to determine the peening intensity. The Almen strip is also visually inspected to determine the coverage of peening. If the complete surface of the Almen strip shows evidence of being contacted by shot, it is commonly concluded that the complete surface of the treated workpiece was also contacted with shot during the peening process. One non-limiting shot peening process is illustrated in FIG. 2. A peening nozzle 200 can be used to direct shot 300 onto a workpiece (not shown) and the top surface of the Almen strip 100 that are both located in the peening chamber (not shown). The Almen strip 100 is typically mounted on a strip holder 400. During the peening process, both the workpiece and a plurality of Almen strips that are mounted to the strip holders are inserted into the peening chamber and are thereafter contacted by the shot 300. After completion of the peening process, one Almen strip 100 and strip holder 400 is removed from the peening chamber. Thereafter, the Almen strip 100 is removed from the strip holder 400 and the degree of deformation of the Almen strip 100 is measured by a measuring device 500. Also, the top surface of the Almen strip 100 is visually inspected to determine the amount of the top surface of the Almen strip that was deformed by the shot 300. The peening process is then restarted such that the workpieces and remaining Almen strips 100 are again subjected to the peening process. This process is repeated until saturation of the Almen strips is achieved. Saturation of the Almen strips 100 occurs when doubling the exposure time of the Almen strip 100 to the shot 300 results in no more than a 10% increase in arc height (a) of the Almen strip 100 and 98+% of the top surface of the Almen strip has been contacted with shot.

FIG. 3 illustrates a graph wherein the x axis is the measured degree of deformation of the Almen strip and the y axis is the relative time period to which the Almen strip is subjected to peening. The small circles on the graph represent data points for each time the Almen strip was removed from the peening chamber and measured. The last two data points on the graph illustrate that the measured degree of deformation of the Almen strip was less than 10% after doubling the exposure time of the Almen strip to the shot, thus representing saturation of the Almen strip.

When the Almen strip 100 has reached saturation and 98+% of the top surface of the Almen strip 100 has been contacted by shot 300, it is determined that the workpiece has been properly subjected to the peening process (e.g., the workpiece has been saturated) and the workpiece is removed from the peening chamber. If the Almen strip 100 has not obtained full saturation and/or less than 98% of the top surface of the Almen strip 100 was not contacted by shot 300, the workpiece can be further subjected to the peening process until the desired amount of peening has been achieved.

Use of a standard prior art Almen strip holder provides adequate information for generally flat and/or simply shaped workpieces. However, for more complex shaped workpieces, the data from the Almen strip is less accurate. For example, when the Almen strip is inserted with one or more coiled springs during a peening process, the Almen strip in a standard Almen strip holder does not take into account the masking/shadowing effect of spring coils, thus incorrectly predicts the peening time required for spring inner diameter (ID) coverage. For coiled springs, the ID coverage from the peening process is important since the ID of the spring is commonly the location of highest applied stress to the coiled spring. As such, when using prior art measurement techniques for measuring the saturation of coiled springs of other complex shaped workpieces, the prior art peening techniques only determine the saturation time for the fully exposed surfaces of the workpieces such as the outer diameter (OD) of a coiled spring, but not the masked surfaces of the workpieces, such as the ID of the coiled spring.

This shortcoming of determining the saturation of complex shaped parts has been addressed by simply subjecting the workpiece to additional peening time in the hope that such additional time will result in the full coverage on the masked portion of the workpiece (e.g., spring ID, etc.). Such technique required the visual examination of the masked portion of the workpiece under microscopic magnification to verify 98%+coverage. Also, this technique commonly resulted in the excessive peening times to ensure that masked portions of the workpiece achieved saturation. Alternatively, x-ray diffraction could be used measure the residual stresses on the masked portion of the workpiece (e.g., spring ID, etc.); however, such process was time consuming and costly.

Another problem with standard prior art Almen strip holders is that the Almen strip holder is commonly formed of solid tool steel and is very heavy compared to the workpieces being peened. This often results in the Almen strip holder sinking to the bottom of the batch of workpieces being peened, thereby resulting in the Almen strip not providing an accurate representation of peening impact to the workpieces. Still another problem with standard prior art Almen strip holders is that the Almen strip holder is conventionally machined with relatively sharp angular corners. When the heavy Almen strip holder with sharp corners is combined with the workpieces, the sharp corners can result in impact damage to the workpieces, thereby resulting in lower fatigue life of the workpiece.

In view of the current state of the art of Almen strip holders, there is a need for an improved test strip holder that can be used better indicate the saturation of complex shaped workpieces in a peening process.

### SUMMARY OF DISCLOSURE

The present disclosure provides a new and improved process of peening to simulate the shadowing effect of workpieces that are being peened to more accurately determine the degree to which a workpiece has been peened, and to an improved test strip holder that can be used to better simulate the shadowing effect of workpieces that are being peened.

In one non-limiting aspect of the present disclosure, there is provided an improved test strip holder that includes a main body that has a strip mount surface configured to receive a test strip. The test strip holder further includes a mask replica structure that is formed on and/or connected to the main body and overlies at least a portion of the strip mount surface on the main body. The mask replica structure is used to partially (e.g., 1-99.9% and all values and ranges therebetween) or fully imitate or simulate structures on a workpiece that partially or fully obstruct one or more other surfaces on the workpiece. The use of the mask replica structure overcomes the shortcomings of prior art Almen strip holders by positioning the mask replica structure at least partially over the top surface of the test strip that is located on the main body, and wherein the mask replica structure has a similar or the same geometry as compared to an actual workpiece being shot peened. As such, the use of the mask replica structure results in an entirely different saturation curve for the workpiece as compared with using a prior art Almen strip holder, and will thus correctly or more correctly predict the saturation time for the workpiece as compared to using a prior art Almen strip holder to predict the saturation time. For example, a coiled spring has inner and outer diameters which have exposed surfaces. The surface of the coiled spring on the outer diameter surface and the surfaces near the outer diameter surface are non-obstructed surfaces. However, the inner diameter surface of the coil spring and the surfaces near the inner diameter surface of the coil spring are partially or fully obstructed by the outer diameter surface and the surfaces near the outer diameter surface. A standard prior art Almen strip holder and prior art Almen strip arrangement can be used to identify when the non-obstructed surfaces of the coil spring are saturated from a peening process; however, the standard prior art Almen strip holder and prior art Almen strip arrangement does not indicate the state of saturation of the partially or fully obstructed surfaces of the coil spring. The mask replica structure can be configured to represent a portion of coil spring (e.g., represent 20-80% [and all values and ranges therebetween] of the coil spring sectioned along a longitudinal axis of the coil spring or along the coils of the coil springs; 45-55% of the coil spring sectioned along a longitudinal axis of the coil spring or along the coils of the coil springs, etc.; and other ranges and limitations are also contemplated). As such, when the mask replica structure is formed on and/or connected to the main body of the test strip holder, the mask replica structure simulates the masking or obstructing effect of the outer diameter surface and the surfaces near the outer diameter surface of the coil spring such that the test strip on the test strip holder more closely represents the saturation of the inner diameter surface of the coil spring and the surfaces near the inner diameter surface of the coil spring during the peening process. During a peening process, both a standard prior art Almen strip holder and prior art Almen strip arrangement and an improved test strip holder that includes a main body and a mask replica structure can optionally be used to determine the saturation of the surfaces of a workpiece during a peening process. In such a peening process, the standard prior art Almen strip holder and prior art Almen strip arrangement can be used to determine the saturation of unobstructed surfaces on the workpiece during a peening process and the improved test strip holder can be used to determine the saturation of partially and/or fully obstructed surfaces on the workpiece during a peening process. As can be appreciated, the improved test strip holder that includes a main body and a mask replica structure can be the only device used during the peening process of a workpiece. In such a process, it can be assumed that the one or more unobstructed surfaces on the workpiece will obtain saturation prior to the one or more obstructed surfaces on the workpiece [the unobstructed surfaces will receive more shot contact during the peening process than the obstructed surfaces]; thus, only the improved test strip holder is needed to determine when the one or more obstructed surfaces on the workpiece have been saturated during the peening process.

In another and/or alternative non-limiting aspect of the present disclosure, there is provided an improved test strip holder that includes a main body that is not limited in shape, size, configuration, and/or material. The main body may be a unitary main body or a composition of two or more main body sub-structures. Generally, the main body is formed of a material that can withstand the peening process. Such materials include metal, wood, ceramic, composite materials, etc. In one non-limiting embodiment, the main body can optionally be partially or fully formed of a material that is hard or harder than the test strip that is to be positioned on the main body. In another non-limiting embodiment, the surface of one or more portions or all of the main body optionally has a hardness that is the same or greater than the surface of the test strip that is to be positioned on the main body. In another non-limiting embodiment, the surface of one or more portions or all of the main body optionally has a hardness that is greater than the surface of the test strip that is to be positioned on the main body. The top surface of the main body generally includes the strip mount surface; however, this is not required. The strip mount surface is generally sized to receive the test strip, though other sizes are contemplated. The test strip holder is deigned to be used with standard shaped, sized, and thick test strips (e.g., Almen “A”, “N” or “C” strips in Grades 3, 2, 1 and 1-S, having a length and width of 76.098 mm×18.987 mm); however, the test strip holder can be used with custom shaped, sized and thick types of test strips. As discuss below, the test strip hold can alternatively or additionally be used with an electronic test strip. The top surface of the strip mount surface is generally flat; however, this is not required. The top surface of the strip mount surface generally is absent slots or openings; however, this is not required. For the avoidance of doubt, a surface designated as a “top” surface is a surface to which a test strip (e.g., an Almen strip, electronic test strip, etc.) is mounted. Accordingly, a “top surface” may have any suitable orientation with respect any other structures. In some embodiments, a main body may have two or more top surfaces, and the multiple surfaces do not need to share a common plane, a common axis, or any other common orientation property.

In another and/or alternative non-limiting aspect of the present disclosure, there is provided an improved test strip holder that includes a main body that has one or more rounded edges that a) results in better mixing of the improved test strip holder with the one or more workpieces during the peening process as compared to the prior art solid rectangular configuration of prior art Almen strip holders that can sink to the bottom of the batch of the workpieces and/or tumble very differently from the workpieces during the peening process, and/or b) inhibits or prevents the main body from causing impact damage to the workpiece during the peening process. Commonly, the one or more workpieces along with the prior art Almen strip holders are tumbled in the peening chamber during the peening process. During such tumbling, sharp edges on the main body of the prior art Almen strip holder can contact one or more workpieces and can thus damage the one or more workpiece. The improved test strip holder includes a main body wherein less than 10% (0-9.999% and all values and ranges therebetween) of the outer surfaces of the main body include sharp or pointed surfaces. In one non-limiting embodiment, 80-100% (and all values and ranges therebetween) of the main body of the improved test strip holder includes rounded edges. The rounded surfaces not only reduce damage to the workpieces during the peening process, but the rounded surface can facilitate in the mixing of the improved test strip holder with the workpieces. For example, when the improved test strip holder is mixed with coiled springs, the bottom portion and/or side portions of the main body can be rounded to partially imitate the shape of the coiled springs, thereby resulting in the main body tumbling and moving with the coil springs in a manner that more closely imitates the tumbling and moving of the coiled springs during the peening process. Such movement of the improved test strip holder with the coiled springs results in a more accurate saturation representation of test strip when compared to the saturation of the coiled springs. In one non-limiting arrangement, 5-90% (and all values and ranges therebetween) of the bottom portion and/or side portions of the main body are shaped to closely or exactly represent the shape of a portion of the workpiece.

In another and/or alternative non-limiting aspect of the present disclosure, there is provided an improved test strip holder that includes a main body having a reduced weight compared to a main body of a prior art Almen strip holder formed of 90-100% of a solid block of material. As discussed herein, the 5-90% (and all values and ranges therebetween) of the bottom portion and/or side portions of the main body can be shaped to closely or exactly represent the shape of a portion of the workpiece. Such shaping of the main body reduces the volume of material used to form the main body, thereby reducing the weight of the main body as compared to the solid rectangular block of material commonly used for prior art Almen strip holders. Additionally, the interior of the main body of the improved test strip holder can include one or more cavities that can also or alternatively be used to reduce the weight of the main body compared to the solid rectangular block of material that is commonly used for prior art Almen strip holders. In at least some cases, a main body may be formed to a weight that fully or partially represents the weight of a standard workpiece. In one non-limiting embodiment, the one or more cavities in the interior of the main body represent 10-90% (and all values and ranges therebetween) the volume of the main body. The shape, number, and/or size of the one or more cavities in the main body are non-limiting. The interior of the main body can optionally include one or more ribs, walls, struts, and/or other support structures to increase the rigidity of the main body that includes the one or more cavities. The reducing in the weight of the main body of the test strip holder can also a) result in better mixing of the improved test strip holder with the one or more workpieces during the peening process compared to the prior art solid rectangular configuration of prior art Almen strip holders that can sink to the bottom of the batch of the workpieces and/or tumble very differently from the workpieces during the peening process, and/or b) inhibit or prevent the main body from causing impact damage to the workpiece during the peening process.

In another and/or alternative non-limiting aspect of the present disclosure, there is provided a test strip holder that includes a mask replica structure that is fully or partially shaped, sized, and/or configured to closely or exactly replicate a portion of a workpiece that is to be peened. Generally, the mask replica structure is formed of a material that can withstand the peening process. Such materials include metal, wood, ceramic, composite materials, etc. Other materials are also contemplated. The material used to partially or fully form the mask replica structure can be the same or different material used to partially or fully form the main body. In one non-limiting embodiment, the mask replica structure is partially or fully formed of a material that is hard or harder than the test strip that is to be positioned on the main body. In another non-limiting embodiment, the surface of one or more portions or all of the mask replica structure has a hardness that is the same or greater than the surface of the test strip that is to be positioned on the main body. In another non-limiting embodiment, the surface of one or more portions or all of the mask replica structure has a hardness that is greater than the surface of the test strip that is to be positioned on the main body. The mask replica structure can be configured to be permanently connected to the main body of the test strip holder or be removably connectable to the main body of the test strip holder. The mask replica structure can be a single-piece structure or a multi-piece structure.

In another and/or alternative non-limiting aspect of the present disclosure, there is provided an improved test strip holder that includes a mask replica structure that includes one or more interior cavities to reduce the weight of the mask replica structure. In one non-limiting embodiment, the one or more cavities in the interior of the mask replica structure represent 10-90% (and all values and ranges therebetween) the volume of the mask replica structure. The shape, number, and/or size of the one or more cavities in the mask replica structure are non-limiting. The interior of the mask replica structure can optionally include one or more ribs, walls, struts, and/or other support structures to increase the rigidity of the mask replica structure that includes the one or more cavities.

In another and/or alternative non-limiting aspect of the present disclosure, there is provided an improved test strip holder that includes a mask replica structure that has the same or similar geometry of a portion of the workpiece so that the exposure of the test strip to the shot during a peening process is the same or substantially the same as the exposure of the partially or fully obstructed surfaces on the workpiece during the same peening process. Such a configuration of the mask replica structure often results in a better representation of the test strip of the surfaces that are partially or fully obstructed on the workpiece. For coiled springs, the mask replica structure is substantially the same or the same in size, shape, and configuration as the 40-60% (and all values and ranges therebetween) of the coil spring along the longitudinal axis of the coil spring. In at least some cases, a mask replica structure may be formed to a weight that fully or partially represents the weight of a standard workpiece. The use of the mask replica structure results in different saturation curves compared to a test strip that is positioned on a prior art Almen strip holder. The saturation curves resulting from use of the mask replica structure often better predict the saturation time required for the workpiece to obtain full saturation of the workpiece. As such, the guess work and/or the costly processes used in the past to verify full saturation of complex shaped workpieces and/or workpieces that include obstructed surfaces can be eliminated by using the mask replica structure in accordance with the present disclosure. The use of the mask replica structure in accordance with the present disclosure can be used to obtain desired peening times for certain shaped workpieces, thus can be used to a) optimize saturation time of such workpieces, and/or b) reduce the time and/or costs associated with obtaining saturated workpieces used prior art Almen strip holders.

In another and/or alternative non-limiting aspect of the present disclosure, there is provided an improved test strip holder that includes a mask replica structure wherein the main body and/or the mask replica structure is partially or fully formed by an additive manufacturing process such as 3D printing. When manufacturing the mask replica structure, use of an additive manufacturing process to partially or fully form the mask replica structure can simplify the manufacturing of the mask replica structure. For some workpieces, the use of conventional subtractive machining techniques to form all or a portion of the mask replica structure is impossible, infeasible, too costly, too time consuming, and/or too difficult to use. The use of an additive manufacturing process to partially or fully form the mask replica structure can be used to obtain a similar or exact geometry of a portion of the workpiece that is to be replicated or closely replicated by the mask replica structure. Also, when the weight of the mask replica structure is reduced by forming one or more internal cavities in the mask replica structure, the additive manufacturing process can be used to cost effectively create such structures in the interior of the mask replica structure (lattice structures, honey comb structures, triangular lattice structures, etc.). In many circumstances, the formation of interior structures in the mask replica structure by conventional manufacturing process (e.g., molding, drilling, cutting, grinding, etc.) is impossible, infeasible, too costly, too time consuming, and/or too difficult to use. When manufacturing the main body of the improved test strip holder in accordance with the present disclosure, the use of an additive manufacturing process to partially or fully form the main body can a) save time and cost when forming the main body, b) form external surfaces and/or internal structures (lattice structures, honey comb structures, triangular lattice structures, etc.) that are impossible, infeasible, too costly, too time consuming, and/or too difficult to form using conventional manufacturing processes. In one non-limiting embodiment, 5-100% (and all values and ranges therebetween) of the main body and/or the mask replica structure is formed by an additive manufacturing process.

In another and/or alternative non-limiting aspect of the present disclosure, there is provided an improved test strip holder that is formed of a single piece of material. In one non-limiting embodiment, an additive manufacturing process is used to form the main body and mask replica structure of the test strip holder. As can be appreciated, other manufacturing processes can be used to form the single-piece test strip holder (e.g., molding, casing, grinding, cutting, drilling, etc.). The single-piece test strip holder that includes a main body and mask replica structure has the advantage of being a simple design.

In another and/or alternative non-limiting aspect of the present disclosure, there is provided an improved test strip holder that is formed of a separate main body and a separate mask replica structure. The main body can be formed of one or more pieces. Likewise, the mask replica structure can be formed of one or more pieces. The material used to form the main body and the mask replica structure can be the same or different. The manufacturing processes used to form the main body and the mask replica structure can be the same or different. When the main body and the mask replica structure are connected together, the connection can be a permanent connection (e.g., solder connection, welded connection, adhesive connection, melted seam connection, etc.) or a releasable connection (e.g., clamp connection, screw connection, bolt connection, etc.). The configuration of the test strip holder that is formed of a separate main body and a separate mask replica structure has the benefit of being able to be disassembled so that a) the main body can be re-ground flat for a longer useful life (e.g., such as for high intensity peening, etc.), and/or b) different mask replica structures can be connected to the same main body. The main body can optionally include one or more slots, grooves, holes, etc., to a) facilitate in the connection of the mask replica structure to the main body, and/or b) ensure proper orientation of the mask replica structure on the main body when connecting the mask replica structure to the main body.

In another and/or alternative non-limiting aspect of the present disclosure, there is provided an improved test strip holder wherein the main body and mask replica structure can be formed as a single piece; however, this is not required.

In another and/or alternative non-limiting aspect of the present disclosure, there is provided an improved test strip holder wherein the mask replica structure can be in the formed of a horizontal cylindrical segment. For example, a horizontal cylindrical segment in the form of a half cylinder that includes one or more openings in the wall of the half cylinder can be used. As can be appreciated, the horizontal cylindrical segment is not limited to a half cylinder, half cylinder, but can be greater or less than a half cylinder. The number, shape and size of the one or more openings in the horizontal cylindrical segment is non-limiting. The horizontal cylindrical segment can be formed of a single piece of material; however, this is not required. The size and shape of two or more of the openings can be the same; however, this is not required. The openings on the horizontal cylindrical segment can be equally spaced from adjacently positioned openings; however, this is not required. Although this non-limiting embodiment was described with particular reference to a horizontal cylindrical segment wherein the cross-sectional shape along the longitudinal axis is partially circular (e.g., semi-circular, quarter-circular to three-quarters circular shape, etc.), it can be appreciated that other cross-sectional shapes can be used (e.g., partially polygonal shape, square shaped, rectangular shaped, triangular shaped, etc.).

In another and/or alternative non-limiting aspect of the present disclosure, there is provided an improved test strip holder wherein the mask replica structure can be in the formed of two or more segments (e.g., two or more horizontal cylindrical segments, etc.). The two or more segments can be nested together and have substantially the same shape; however, this is not required. The two or more segments can be permanently fixed in place with respect to one another or be movable with respect to one another. In one non-limiting embodiment, there is provided two horizontal cylindrical segments that are nested together. The two horizontal cylindrical segments can optionally be movable adjustable (e.g., mechanically-adjustable) with respect to one another so that the size and/or shape of the openings through the two horizontal cylindrical segment can be adjusted.

In another and/or alternative non-limiting aspect of the present disclosure, there is provided an improved test strip holder wherein all or a portion of the outer surface of the main body and/or mask replica structure can optionally be coated with a protective coating (nitriding coating, carburization coating, ceramic coating, metal coating, DLC (diamond like coating), titanium nitride coating, TiN coating, TINOx coating, etc.). Such protective coating may be provided to improve the life of the main body and/or mask replica structure or for another reason. The thickness of the optional coating is non-limiting. In one non-limiting embodiment, the optional coating that is coated partially or fully on the outer surface of the main body and/or the mask replica structure has a hardness that is hard or harder than the test strip that is to be positioned on the main body.

In another and/or alternative non-limiting aspect of the present disclosure, there is provided an improved test strip holder wherein the main body and/or mask replica structure includes one or more strip connection arrangements used to connect the test strip to the main body. Generally, such strip connection arrangements are configured to releasably connect the test strip to the main body. Such arrangement can include screws, bolts, clamps, retention tabs, hook and look fastener, adhesive, etc.).

In another and/or alternative non-limiting aspect of the present disclosure, the test strip can be partially or fully substituted for an electronic test strip. The electronic test strip is configured to detect/calculate a) the contact of each or a portion or all of the particles (e.g., peen balls, peening media, etc.) on the electronic test strip, b) the location of contact of each or a portion or all of the particles on the electronic test strip, c) the impart force of each or a portion or all of the particles on the electronic test strip, and/or d) the energy of each or a portion or all of the particles contacting the electronic test strip. Each impact of the peening media on the electronic test strip has a different level of force and energy due to the size, hardness and velocity of each particle of the peening media that contacts the electronic test strip. Each of these impacts by the peening media on the electronic test strip can be recorded and processed a processor and software to calculate a value (e.g., output voltage, etc.) that is used to determine an Almen intensity. The electronic test strip can be configured to send the detected/calculated data via a wired connection and/or a wireless connection to a remote storage device, processing device and/or electronic display (e.g., cloud storage, smart device [e.g., smart phone, tablet, etc.], laptop computer, desktop computer, server, monitor, TV, laptop screen, etc.). The data obtained by the electronic test strip can be partially or fully processed in the electronic test strip and/or partially or fully processed by an external device to which the data is wired or wirelessly sent from the electronic test strip. The processed data can be used to produce a real-time or near real-time Almen intensity value (e.g., Almen intensity value generated in less than 1 minute of data collection by the electronic test strip; Almen intensity value generated in less than 1 minute after data transmitted from the electronic test strip to an external processor, etc.). If more than one electronic test strip is used in a particular peening process and the data for each of the electronic test strips is wirelessly transmitted, each of the electronic test strips can optionally include wireless transmission protocols so that an external receiver can distinguish the transmitted data from each of the electronic test strips. The electronic test strip can include a) a peening media, b) one or more contact sensors and/or pressure sensors, c) an internal power source (e.g., battery [e.g., rechargeable battery, non-rechargeable battery], capacitor, etc.), d) one or more processors, e) storage, f) wireless transmitter/receiver, and/or g) software for the processing of data. As can be appreciated, the electronic test strip can include additional components. In one non-limiting configuration, the electronic test strip includes a peening media that is positioned over one or more sensors. The size and/or shape and/or thickness of the electronic test strip can be the same or similar (e.g., within 10%) of a standard prior art Almen strip. The electronic test strip can be configured to be reusable for two or more uses. As such, the electronic test strip can be configured to remain on the test strip holder for multiple uses without having to be removed after each use.

In one non-limiting object of the present disclosure, there is provided a strip holder system comprising a) a main body, the main body including a top surface adapted to receive a test strip; and b) a mask replica structure, the mask replica structure adapted to be connectable to the main body and overlie a portion of the top surface of the main body when connected to the main body.

In another and/or alternative non-limiting object of the present disclosure, there is provided a strip holder system wherein the test strip is prior art Almen strip and/or an electronic test strip.

In another and/or alternative non-limiting object of the present disclosure, there is provided a strip holder system wherein the mask replica structure is permanently connected to the main body.

In another and/or alternative non-limiting object of the present disclosure, there is provided a strip holder system wherein the mask replica structure is releasably connectable to the main body.

In another and/or alternative non-limiting object of the present disclosure, there is provided a strip holder system wherein the mask replica structure is formed of the same material as the main body.

In another and/or alternative non-limiting object of the present disclosure, there is provided a strip holder system wherein the mask replica structure and/or the main body is at least partially formed by an additive manufacturing process.

In another and/or alternative non-limiting object of the present disclosure, there is provided a strip holder system wherein the mask replica structure and/or the main body include one or more cavities in an interior of the mask replica structure and/or the main body.

In another and/or alternative non-limiting object of the present disclosure, there is provided a strip holder system wherein the mask replica structure and/or the main body include a strip connection structure configured to secure the test strip to the mask replica structure and/or the main body.

In another and/or alternative non-limiting object of the present disclosure, there is provided a strip holder system wherein the mask replica structure includes the strip connection structure; the strip connection structure includes one or more securing tabs in the mask replica structure that is configured to entrap at least a portion of the test strip between the securing tabs and the top surface of the main body.

In another and/or alternative non-limiting object of the present disclosure, there is provided a strip holder system wherein the main body includes the strip connection structure; the strip connection structure includes one or more connection openings configured to receive a connector that is configured to entrap at least a portion of the test strip between the connector and the top surface of the main body.

In another and/or alternative non-limiting object of the present disclosure, there is provided a strip holder system wherein the main body includes one or more rounded and/or tapered edges.

In another and/or alternative non-limiting object of the present disclosure, there is provided a strip holder system wherein a bottom portion of the main body includes one or more rounded and/or tapered edges.

In another and/or alternative non-limiting object of the present disclosure, there is provided a strip holder system wherein the mask replica structure has a shape, size, and/or configuration that is the same or similar to a structure on a workpiece that obstructs one or more surfaces on the workpiece.

In another and/or alternative non-limiting object of the present disclosure, there is provided a strip holder system wherein the mask replica structure has a shape, size, and/or configuration that is the same or similar to an upper portion of a coil spring that was cut along a longitudinal axis of the coil spring.

In another and/or alternative non-limiting object of the present disclosure, there is provided a strip holder system wherein the mask replica structure and/or the main body includes a protective coating on one or more portions of an outer surface of the mask replica structure and/or the main body.

In another and/or alternative non-limiting object of the present disclosure, there is provided a strip holder system wherein the protective coating has a hardness that is greater than a hardness of an outer surface of the mask replica structure and/or the main body.

In another and/or alternative non-limiting object of the present disclosure, there is provided a strip holder system wherein the main body includes a mask connection arrangement that is configured to receive a portion of the mask replica structure to facilitate in connecting the mask replica structure to the main body.

In another and/or alternative non-limiting object of the present disclosure, there is provided a strip holder system wherein the mask replica structure includes a leg that is configured to be at least partially inserted in the mask connection arrangement.

In another and/or alternative non-limiting object of the present disclosure, there is provided a method for determining a partial or full saturation of a workpiece that includes an obstruction structure that obstructs outer surface of the workpiece from shot during a peening process comprising a) providing a strip holder system, the strip holder system including i) a main body, the main body including a top surface adapted to receive a test strip; and ii) a mask replica structure, the mask replica structure adapted to be connectable to the main body and overlie a portion of the top surface of the main body when connected to the main body, the mask replica structure having a configuration that is the same or similar to the obstruction structure on the workpiece; b) providing the test strip and/or an electronic test strip; c) securing the test strip and/or an electronic test strip to the top surface of the main body of the strip holder system, at least a portion of the mask replica structure overlying at least a portion of the test strip and/or an electronic test strip when the test strip and/or an electronic test strip is secured to the top surface of the main body of the strip holder system and the mask replica structure is connected to the main body; d) subjecting the strip holder system and the workpiece to shot or some other peening media in a peening process; and, e) optionally testing the test strip after the step of subjecting to obtain information about a saturation of the workpiece and/or collecting, analyzing and/or viewing data connected by the electronic test strip.

In another and/or alternative non-limiting object of the present disclosure, there is provided a method for determining a partial or full saturation of a workpiece wherein the strip holder system has the same or similar weight to the workpiece.

In another and/or alternative non-limiting object of the present disclosure, there is provided a strip holder system comprising: a main body; said main body including a top surface adapted to receive a test strip; and a mask replica structure; said mask replica structure configured to overlie a portion of said top surface of said main body when connected to said main body; said mask replica structure a) is formed from a same single piece of material as said single piece of material used to form said main body, or b) is a separate and removable component from said main body, and wherein said mask replica structure include two mask sections that are configured to move relative to one another, and wherein each of said two mask sections includes one or more openings in a sidewall of each of said two mask sections, and wherein relative movement of said two mask sections to one another results in a size and/or shape of an opening though a side of said mask replica structure to be changed; and wherein said test strip is prior art Almen strip or an electronic test strip.

This Summary has been provided to describe certain concepts in a simplified form that are further described in more detail in the Detailed Description. The Summary does not limit the scope of the claimed subject matter, but rather the words of the claims themselves determine the scope of the claimed subject matter. These and other advantages will become apparent to those skilled in the art upon the reading and following of this description.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is an illustration of non-limiting prior art Almen strips that can be used with the improved test strip holder that is in accordance with the present disclosure.

FIG. 2 is an illustration of one non-limiting prior art Almen strip testing process that can be used in accordance with the present disclosure.

FIG. 3 is a saturation curve that is commonly used to determine the saturation of the prior art Almen strip that has been subjected to a peening process.

FIG. 4 is a non-limiting single-piece improved test strip holder in accordance with the present disclosure that includes a main body and mask replica structure.

FIGS. 5A-5C is a non-limiting multi-piece improved test strip holder in accordance with the present disclosure that includes a main body and mask replica structure wherein the mask replica structure is removably connectable to the main body.

FIGS. 6A-6C is another non-limiting multi-piece improved test strip holder in accordance with the present disclosure that includes a main body and mask replica structure wherein the mask replica structure is removably connectable to the main body.

FIG. 7 is another non-limiting improved test strip holder in accordance with the present disclosure that includes a main body and mask replica structure wherein the mask replica structure is removably connectable to the main body. The improved test strip holder can be a single-piece device or the mask replica structure can be configured to be removably connectable to the main body.

FIGS. 8 and 9 are another non-limiting improved test strip holder in accordance with the present disclosure that includes a main body and mask replica structure. The mask replica structure is formed of two components, and wherein the two component can be permanently fixed in relationship to one another or can be moveably or adjustably positioned with respect to one another to adjust the number and/or size of the one or more openings through the mask replica structure.

FIG. 10 is a schematic diagram of an exemplary system configured to generate a saturation curve and/or an Almen intensity by use of an electronic test strip in the improved test strip holder in accordance with the present disclosure.

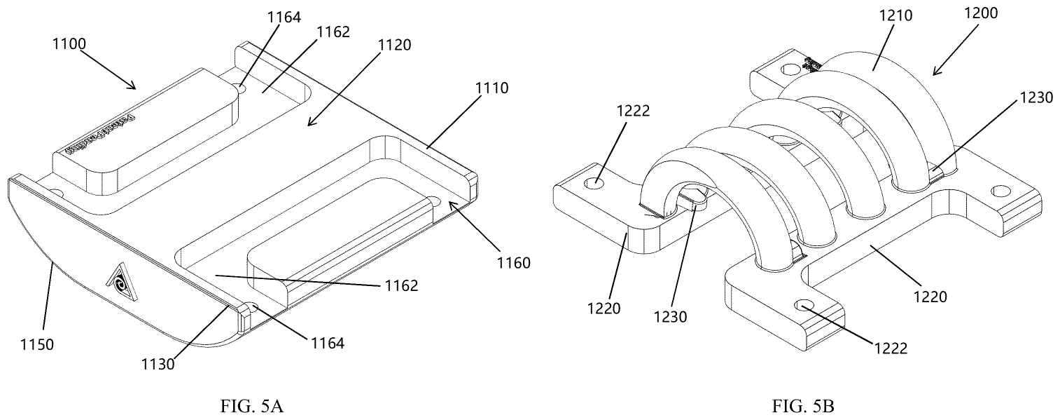

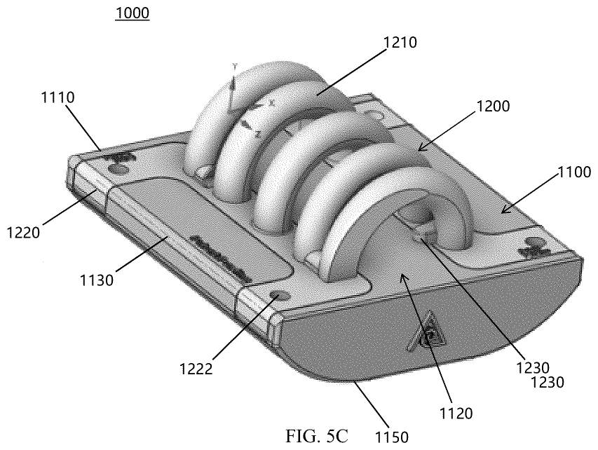

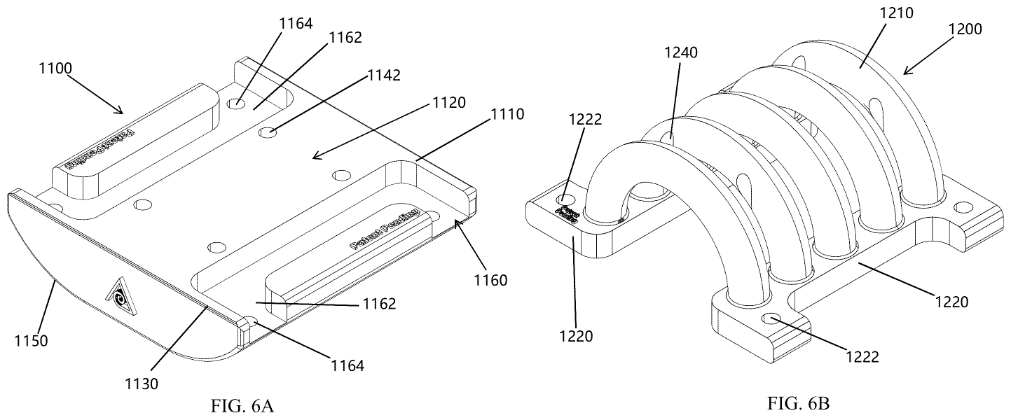

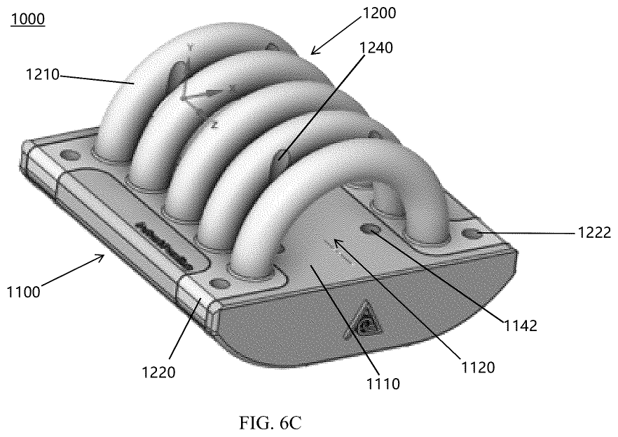

In the present disclosure, for brevity, certain sets of related figures may be referred to as a single, multi-part figure to facilitate a clearer understanding of the illustrated subject matter. For example, FIGS. 5A-5C may be individually or collectively referred to as FIG. 5. FIGS. 6A-6C may be individually or collectively referred to as FIG. 6. Structures earlier identified are not repeated for brevity.

### DETAILED DESCRIPTION OF VARIOUS NON-LIMITING EMBODIMENTS OF THE DISCLOSURE

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having.” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

The inventors have conceived of novel technology that, for the purpose of illustration, is disclosed herein as applied in the context of an apparatus and method for metal treatment analysis. While the disclosed applications of the inventors' technology satisfy a long-felt but unmet need in the art of metal treatment analysis, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

Implementations of the disclosed technology may include a sensor capable of wireless operation, and which incorporates active circuitry for sensing and recording of peen ball contact. In such implementations, active circuitry differentiates itself from conventional internal sensors in that it may be configured for on board signal processing and data discrimination, data storage, and more reliable digital data transmission of the sensing modality. In further variations of the disclosed technology, the implantable sensor may include, for example, a sensor which is connected to active circuitry which provides signal processing, data acquisition and digital processing of the signal to extract signal features; may contain digital storage where signal features, or raw signal can be stored; and may include a wireless communication system which allows digital signal transmission (e.g., via inductively coupled wireless link, Bluetooth Low Energy (“BLE”), RFID, or another wireless communication interface).

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”), random access memory (“RAM”), magnetic disk storage media, optical storage media, flash memory devices, and electrical, optical, acoustical or other form of propagated signals (e.g., carrier waves, infrared signals, digital signals, etc.).

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

One non-limiting exemplary embodiment is described herein. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

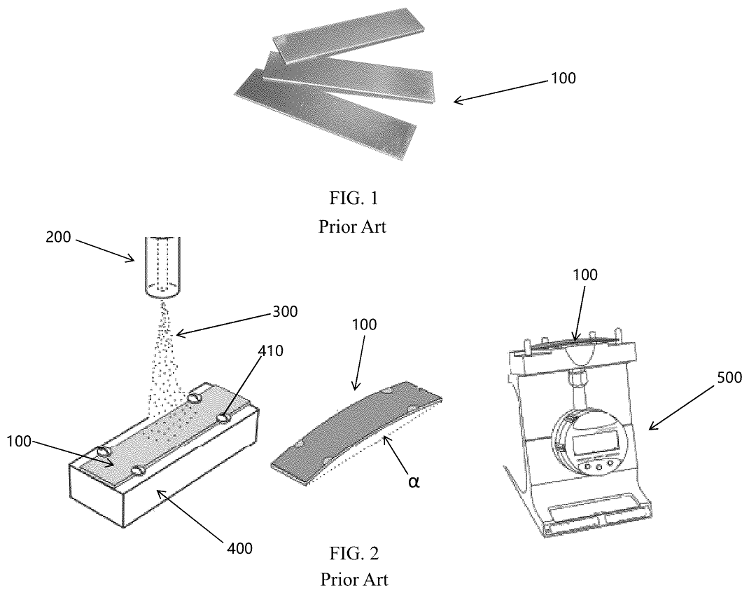

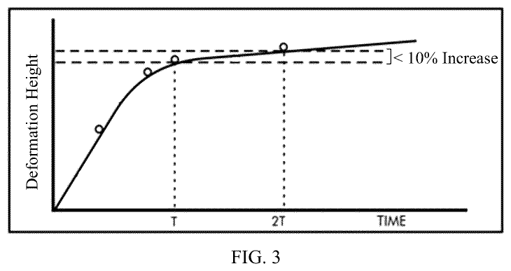

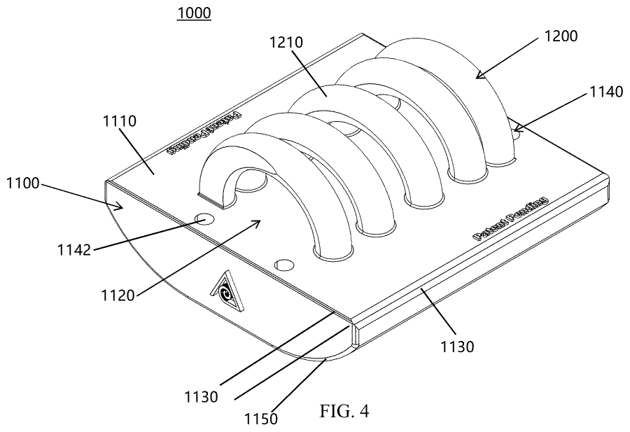

Referring now to FIGS. 4-6, there is illustrated an improved test strip holder 1000 that can be used with standard prior art Almen strips 100 (as illustrated in FIG. 1) or an electronic test strip that can be used in a prior art Almen strip testing process (as illustrated in FIG. 2) to generate a saturation curve (as illustrated in FIG. 3) and/or an Almen intensity to determine whether a workpiece has been fully saturated during a peening process.

As illustrated in FIGS. 4-6, the improved test strip holder 1000 in accordance with the present disclosure includes a main body 1100 and a mask replica structure 1200. The top surface 1110 of the main body is illustrated as including a generally flat portion at or near the center region 1120 of the top surface 1110. The top surface 1110 is configured to receive a test strip such as an Almen strip 100 or an electronic test strip. The shape and size of the main body 1100 is non-limiting. One or more edges 1130 of the main body 1100 can optionally be rounded and/or tapered so as to minimize sharp edges on the main body 1100 and/or to facilitate in the tumbling of the test strip holder 1000 during a peening process to more closely match the movement of the test strip holder 1000 with the workpiece during the peening process. Likewise, one or more portions of the bottom surface 1150 of the main body 1100 can optionally include tapered and/or rounded edges and/or surfaces to minimize sharp edges on the main body 1100 and/or to facilitate in the tumbling of the test strip holder 1000 during a peening process to more closely match the movement of the test strip holder 1000 with the workpiece during the peening process.

For brevity and not limitation, the test strip of the present disclosure may be interchangeably referred to herein as any type of an Almen strip 100 or an electronic test strip. Those of skill in the art will recognize that a test strip may have any suitable length, width, depth, height, thickness, shape, dimensions, or other physical properties. In addition, a test strip may be formed of any suitable material, and a test strip may conform to any standardized testing protocol, proprietary testing protocol, or other testing protocol. When the test strip is an Almen strip, the Almen strip can be any type of prior art Almen strip. As discussed above, a prior art Almen strip 100 is a thin strip of SAE 1070 steel. When the test strip is an electronic test strip, the electronic test strip is generally configured to detect/calculate a) the contact of each or a portion or all of the particles (e.g., peen balls, peening media, etc.) on the electronic test strip, b) the location of contact of each or a portion or all of the particles on the electronic test strip, c) the impart force of each or a portion or all of the particles on the electronic test strip, and/or d) the energy of each or a portion or all of the particles contacting the electronic test strip. The electronic test strip can be configured to send the detected/calculated data via a wired connection and/or a wireless connection to a remote storage device, processing device and/or electronic display. The data obtained by the electronic test strip can be partially or fully processed in the electronic test strip and/or partially or fully processed by an external device to which the data is wired or wirelessly sent from the electronic test strip. The electronic test strip can include a) a peening media, b) one or more contact sensors and/or pressure sensors, c) an internal power source, d) one or more processors, e) storage, f) wireless transmitter/receiver, and/or g) software for the processing of data. As can be appreciated, the electronic test strip can include additional components. In one non-limiting configuration, the electronic test strip includes a peening media that is positioned over one or more sensors. The size and/or shape and/or thickness of the electronic test strip can be the same or similar of a standard prior art Almen strip.

The main body can include one or more strip connection arrangements 1140 that are used to secure the test strip 100 to the top surface 1110 of the main body 1100. As illustrated in FIG. 4, the main body includes a plurality of openings 1142 that are configured to receive a screw, bolt, etc. (not shown) to releasably secure the test strip 100 to the top surface 1110 of the main body 1100. As illustrated in FIG. 5, the mask replica structure 1200 includes one or more strip retention tabs 1230 that that are used to secure the test strip 100 to the main body 1100. In the non-limiting arrangement illustrated in FIG. 5, the one or more strip retention tabs 1230 are configured to secure the test strip 100 to the main body 1100 when the mask replica structure 1200 is connected to the main body 1100. As can be appreciated, other or additional structures, mechanisms, processes, or the like (i.e., strip connection arrangements 1140, 1230) can be used to permanently or releasably secure the test strip 100 to the top surface 1110 of the main body 1100.

Referring again to FIG. 4, the test strip holder 1000 in accordance with the present disclosure is a one-piece unit. In such an arrangement, the test strip holder 1000 is formed of the same material; however, this is not required. The manufacturing process for the one-piece Test strip holder 1000 is non-limiting (e.g., additive manufacturing process, molding, casting, grinding, drilling, cutting, welding, soldering, masking, printing, vapor deposition, etc.). In one non-limiting arrangement, the one-piece test strip holder 1000 is partially or fully formed by an additive manufacturing process (e.g., 3D printing, etc.). During such additive manufacturing process, the same or different materials can be used to form one or more portions of the one-piece test strip holder 1000.

The mask replica structure 1200 is illustrated to be in the form of a plurality of semi-circular bars 1210 that partially overlie the center region 1120 of the top surface 1110 of the main body 1100. In the non-limiting mask replica structure 1200 illustrated in FIG. 4, the mask replica structure 1200 is shaped to be the same or similar to a top-half portion of a coiled spring that is to be subjected to the peening process. At least a portion of the mask replica structure 1200 overlies one or more portions of the center region 1120 of the top surface 1110 of the main body 1100. The mask replica structure is sized and shaped so that the test strip 100 is positioned on the top surface 1110 of the main body 1100.

The mask replica structure 1200 is configured to create an obstruction of the shot in a peening process to the top surface 1110 of the main body 1100 wherein the test strip 100 is to be positioned. This arrangement of the mask replica structure 1200 simulates the obstruction that the outer surfaces of a coiled spring would cause to the shot to the inner diameter surface of the coiled spring during a peening process. As such, when the test strip 100 is analyzed and/or data is obtained and/or transmitted from the test strip 100, the analyzed test strip 100 or data obtained/transmitted form the test strip 100 closely resembles the saturation status of the inner diameter of the coil spring. The mask replica structure 1200 can thus be shaped to closely or exactly match the shape of an upper half of a coiled spring or any other portion of any other workpiece. As illustrated in FIGS. 4-6, the shape of the mask replica structure can be customized to different shaped coiled springs. Although the shape of the mask replica structure 1200 has been described with respect to a coiled spring that is be subjected to a peening process, it will be appreciated that the mask replica structure 1200 can be shaped into any shape that is the same or closely resembles one or more portions of a workpiece that has one or more obstructed structures. As such, the shape of the mask replica structure 1200 is non-limiting.

The main body 1100 and/or the mask replica structure 1200 can optionally include one or more internal voids and/or be formed of a lighter material than an outer portion of the main body 1100 and/or mask replica structure 1200 to reduce the weight of the main body 1100 and/or mask replica structure 1200. The main body 1100 and/or the mask replica structure 1200 can optionally include an outer coating on one or more outer portions of the main body 1100 and/or mask replica structure 1200 to improve the durability and/or life of the main body 1100 and/or mask replica structure 1200.

Referring now to FIGS. 5-6, there is illustrated a test strip holder 1000 that includes a separate main body 1100 and a separate mask replica structure 1200 wherein the mask replica structure 1200 can be permanently connected or releasably connected to the main body 1100.

The main body 1100 is illustrated as including a mask connection arrangement 1160 that is used to facilitate in the connection of the mask replica structure 1200 to the main body 1100. As illustrated in FIGS. 5 and 6, the mask connection arrangement 1160 includes a slot or groove arrangement 1162 and a connection opening arrangement 1164 on each side of the main body 1100. The mask replica structure 1200 includes two base legs 1220 that have a shape and size that is configured to be inserted into the slot or groove arrangement 1162 (as illustrated in FIGS. 5C and 6C). The base legs 1220 each include openings 1222 that are sized and positioned on the base legs to align with the connection opening arrangements 1220 such that a screw, bolt, etc., can be used to secure the mask replica structure 1200 to the main body 1100. As can be appreciated, many other connection arrangements can be used to permanently or releasably connect the mask replica structure 1200 to the main body 1100.

As illustrated in FIGS. 6B and 6C, the mask replica structure 1200 can optionally include one or more access slots 1240 to allow access to the openings 1142 on the main body 1100 so that the test strip 100 can be connected to and/or removed from the main body without having to remove the mask replica structure from the main body 1100.

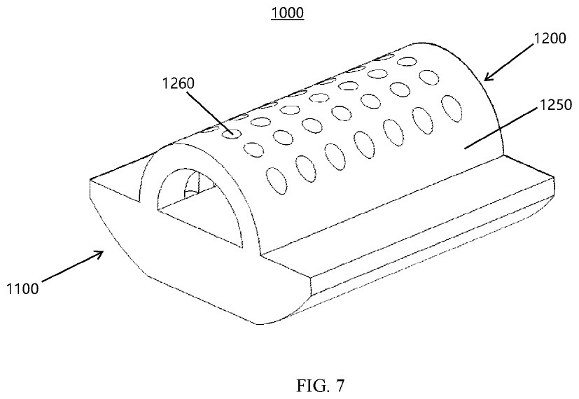

Referring now to FIG. 7, a test strip holder 1000 that includes a main body 1100 and a mask replica structure 1200 formed form a single material. The one piece test strip holder can be formed by a molding process, 3D printing, or by some other process or some combination of processes. As can be appreciated, the mask replica structure 1200 can be a separate piece from the main body 1100 and can be connected to the main body 1100 by one or more of the arrangement discussed above or by some other arrangement. The mask replica structure 1200 has the shape of a horizontal cylindrical segment that includes a plurality of openings 1260 in the sidewall 1250 of the horizontal cylindrical segment. The size and shape of the openings are non-limiting. Also, the orientation of the openings 1260 on the sidewall 1250 of the mask replica structure 1200 is non-limiting. The openings 1260 pass fully through the sidewall 1250 so that the peening material can pass through the sidewall 1260 and contact the test strip 100 on the main body 1100.

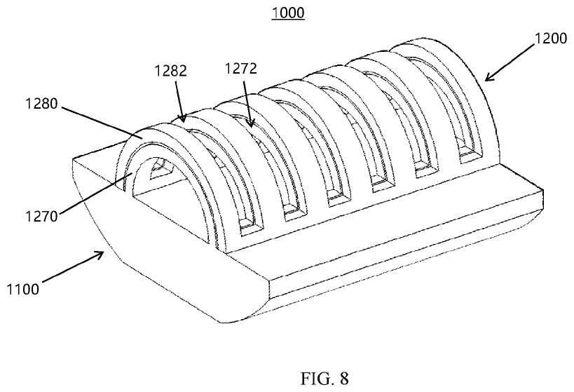

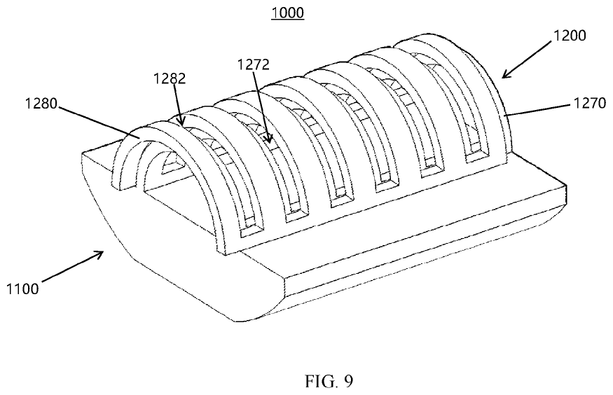

Referring now to FIGS. 8 and 9, a test strip holder 1000 that includes a main body 1100 and a mask replica structure 1200, and wherein the mask replica structure is formed or two mask segments 1270, 1280 that are nested together. Each of mask segments 1270, 1280 includes openings 1272, 1282 in the sidewall of the mask segments 1270, 1280. The openings 1272, 1282 are illustrated as having the generally same shape, namely an arcuate slot shape; however, other shapes (e.g., oval shapes, circular shapes, etc.) can be used. The number of opening 1272, 1282 on each of the mask segments 1270, 1280 is illustrated as being the same; however, this is not required. The positioning of the openings on the sidewall of the mask segments 1270, 1280 is illustrated as being the same; however, this is not required. The number and shape of the openings 1272, 1282 on each of the mask segments 1270, 1280 are non-limiting. As illustrated in FIG. 8, mask segments 1270, 1280 are aligned with one another such that openings 1272, 1282 are aligned with one another. Referring now to FIG. 9, mask segment 1280 has been moved (e.g., slidably moved) or otherwise oriented relative to mask segment 1270 such that openings 1272, 1282 are no long aligned with one another, this the size of the passageway through the side of the mask replica structure 1200 has been reduced. The ability to adjustably move one mask segment with respect to another mask segments enables the number and/or size of the openings through the sidewall of the mask replica structure 1200 to be adjusted to that different sized parts can be tested using a single type of test strip holder 1000. As can be appreciated, once the mask segment are oriented to one another is a desired configuration, one or both of the mask segments can be secured in position by a securing arrangement (e.g., screw, bolt, clamp, post, clip, etc.). As can be appreciated, different sized, shaped and configured mask segments 1270, 1280 can be used to different parts so as to accurate emulate and measure the peening of the parts during a peening process.

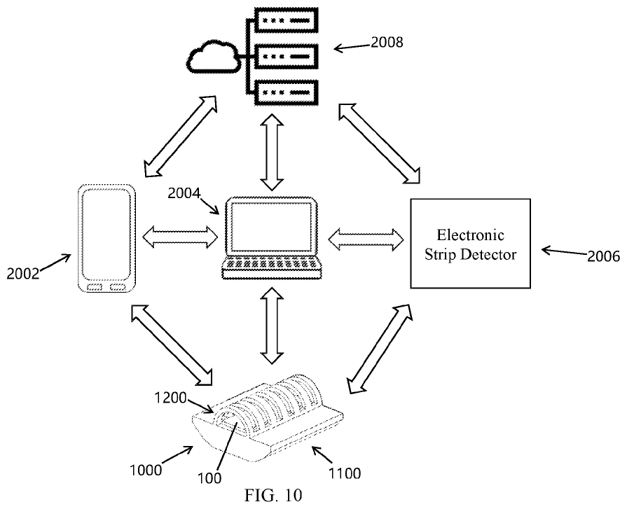

Referring now to FIG. 10, there is illustrated a test strip holder 1000 that includes a main body 1100 and a mask replica structure 1200, and an electronic test strip 100 positioned on the main body 1100 and at least partially beneath the mask replica structure 1200. The electronic test strip 100 is configured to be impacted by peening material during the peening of parts (not shown). The electronic test strip 100 can be configured to actively the impact of peening material on the electronic test strip 100 (e.g., on a continuous basis, intermittently, upon a configured schedule, in response to an external input, etc.), and to locally store information about the peening material impacting the electronic test strip 100.

A device 2002, 2004, 2006, 2008 may be configured to interface with the electronic test strip 100 from time to time via a short-range wireless interface in order to receive locally stored information about peen material impact on the electronic test strip 100 and other data. Supported user devices will vary by a particular implementation, and for example may include a mobile device 2002, a personal computer 2004) a proprietary device such as a test strip reader 2006, and other devices having processors and other components as may be useful for receiving, providing, analyzing, modifying, and storing data, and communicating via the short-range wireless interface or other communication interfaces. The arrows in FIG. 10 represent wired and/or wireless communication between the electronic test strip 100 and one or more devices, and also wired and/or wireless communication between the one or more devices.

In addition to communicating with the electronic test strip 100 as an external device, the user device may also be configured to communicate with a remote server 2008, directly or indirectly, via an internet connection or other communication interface. The remote server 2008 may include one or more cloud, virtual, physical, or other servers or server environments, each having processors, memories, and other components as may be useful for receiving, providing, analyzing, modifying, and storing data, and communicating via the internet or other communication interfaces. The remote server 2008 may be configured to receive peen material impact information, other sensor data, and other information originating from the electronic test strip 100 and/or user device, and may be configured to perform analyses of that data, or provide some or all of that data to a user, or other third parties via a user interface and a display, via an application programming interface (“API”), via a web service or other software application, or via other interfaces. The remote server 2008 may also be configured to provide software applications, user interfaces, electronic test strip 100 configurations (e.g., sensor data processing software, device firmware, sensor calibrations, software configurations, etc.) to the user device from time to time, which may be provided to the electronic test strip 100 by the user device upon a subsequent interaction. The electronic test strip 100 typically includes a) a peening media (e.g., top plate, b) one or more contact sensors and/or pressure sensors, c) an internal power source, d) one or more processors, e) storage, f) wireless transmitter/receiver, and g) software for the processing of data so as to obtain, store and transmit peen material impact information, other sensor data, and other information originating from the electronic test strip 100 to one or more user devices. As can be appreciated, the one or more devices 2002, 2004, 2006, 2008 can likewise include a) an internal power source, b) one or more processors, c) storage, d) wireless transmitter/receiver, e) communication interfaces, f) optional display, and g) software for the processing of data.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed:

1. A strip holder system comprising:
a main body; said main body including a top surface adapted to receive a test strip; and
a mask replica structure; said mask replica structure adapted to be connectable to said main body and overlie a portion of said top surface of said main body when connected to said main body.

2. The strip holder system as defined in claim 1, wherein said test strip is an Almen strip or an electronic test strip.

3. The strip holder system as defined in claim 1, wherein said mask replica structure is permanently connected to said main body.

4. The strip holder system as defined in claim 1, wherein said mask replica structure is releasably connectable to said main body; said main body includes a mask connection arrangement that is configured to receive a portion of said mask replica structure to facilitate in connecting said mask replica structure to said main body.

5. The strip holder system as defined in claim 1, wherein said mask replica structure is formed of the same material as said main body.

6. The strip holder system as defined in claim 1, wherein said mask replica structure and/or said main body is at least partially formed by an additive manufacturing process.

7. The strip holder system as defined in claim 1, wherein said mask replica structure and/or said main body include one or more cavities in an interior of said mask replica structure and/or said main body.

8. The strip holder system as defined in claim 1, wherein said mask replica structure and/or said main body include a strip connection structure configured to secure the test strip to said mask replica structure and/or said main body.

9. The strip holder system as defined in claim 8, wherein said mask replica structure includes said strip connection structure; said strip connection structure includes one or more securing tabs in said mask replica structure that is configured to entrap at least a portion of the test strip between said securing tabs and said top surface of said main body.

10. The strip holder system as defined in claim 8, wherein said main body includes said strip connection structure; said strip connection structure includes one or more connection openings configured to receive a connector that is configured to entrap at least a portion of the test strip between said connector and said top surface of said main body.

11. The strip holder system as defined in claim 1, wherein said main body includes one or more rounded and/or tapered edges.

12. The strip holder system as defined in claim 1, wherein a bottom portion of said main body includes one or more rounded and/or tapered edges.

13. The strip holder system as defined in claim 1, wherein said mask replica structure has a shape, size, and/or configuration that is the same or similar to a structure on a workpiece that obstructs one or more surfaces on the workpiece.

14. The strip holder system as defined in claim 13, wherein said mask replica structure has a shape, size, and/or configuration that is the same or similar to an upper portion of a coil spring that was cut along a longitudinal axis of the coil spring.

15. The strip holder system as defined in claim 1, wherein said mask replica structure and/or said main body includes a protective coating on one or more portions of an outer surface of said mask replica structure and/or said main body.

16. The strip holder system as defined in claim 15, wherein said protective coating has a hardness that is greater than a hardness of an outer surface of said mask replica structure and/or said main body.

17. A strip holder system comprising:
a main body; said main body including a top surface adapted to receive a test strip; and
a mask replica structure; said mask replica structure configured to overlie a portion of said top surface of said main body when connected to said main body; said mask replica structure a) is formed from a same single piece of material as said single piece of material used to form said main body, or b) is a separate and removable component from said main body, and wherein said mask replica structure include two mask sections that are configured to move relative to one another, and wherein each of said two mask sections includes one or more openings in a sidewall of each of said two mask sections, and wherein relative movement of said two mask sections to one another results in a size and/or shape of an opening though a side of said mask replica structure to be changed; and
wherein said test strip is an Almen strip or an electronic test strip.

18. The strip holder system as defined in claim 17, wherein said mask replica structure includes a leg that is configured to be at least partially inserted in said mask connection arrangement.

19. A method for determining a partial or full saturation of a workpiece that includes an obstruction structure that obstructs outer surface of the workpiece from shot during a peening process comprising:
a. providing a strip holder system, said strip holder system including:
a main body; said main body including a top surface adapted to receive a test strip; and
a mask replica structure; said mask replica structure adapted to be connectable to said main body and overlie a portion of said top surface of said main body when connected to said main body; said mask replica structure having a configuration that is the same or similar to said obstruction structure on said workpiece;
b. providing said test strip;
c. securing said test strip to said top surface of said main body of said strip holder system, at least a portion of said mask replica structure overlying at least a portion of said test strip when said test strip is secured to said top surface of said main body of said strip holder system and said mask replica structure is connected to said main body;
d. subjecting said strip holder system and said workpiece to peening media in a peening process; and,
e. testing said test strip after said step of subjecting to obtain information about a saturation of said workpiece or collecting electronic data from said test strip that is generated during said step of subjecting said strip holder system and said workpiece to peening media in a peening process.

20. The method as defined in claim 19, wherein said strip holder system has the same or similar weight to said workpiece.
